(19) United States
(12) Patent Application Publication
(10) Pub. No.: US 2005/0013905 A1
(43) Pub. Date: Jan. 20, 2005

(54) Insulated pouch

(75) Inventor: John Michael Hughes, Goshen, NY (US)

Correspondence Address: UNILEVER;PATENT DEPARTMENT, 45 RIVER ROAD, EDGEWATER, NJ, 07020, US

(73) Assignee: Unilever Bestfoods North America

(21) Appl. No.: 10/621,279

(22) Filed: Jul. 16, 2003

(51) Int. Cl. C12C 1/027

(52) U.S. Cl. 426/106

(57) ABSTRACT

The invention is directed to an insulated pouch. The insulated pouch has a flexible bag and an insulating layer, and is suitable to heat food product in a microwave oven. The insulated pouch can be comfortably held after being heated by a consumer and food product can be consumed directly therefrom without requiring the use of conventional dishware.

### FIELD OF THE INVENTION

The present invention is directed to an insulated pouch. More particularly, the invention is directed to an insulated pouch suitable for use with a food product. The insulated pouch, with food product therein, may be subjected to microwaves in a microwave oven so that the food product can be heated to the desired serving temperature. Subsequent to heating in the microwave oven, the insulated pouch may be conveniently held by a consumer while the heated food product is being consumed.

### BACKGROUND OF THE INVENTION

In the modern hectic world, ready to eat meals are highly desired. While, for example, ready to eat meals comprising soups, pastas and meats are available, it is very difficult to find such meals in convenient to heat and eat packaging.

Meals packaged in pouches with perforations have been sold. Such meals, however, are typically boiled in water and drained prior to serving. The resulting heated meals cannot be served in the perforated packaging they are boiled in and are typically served on conventional plates and with kitchen utensils.

Sauces have been packaged in microwave safe packages that are insulated. Particularly, such sauces are packed in a bag having a small orifice so that the sauce can be poured out onto a meal being consumed with conventional dishware.

It is desirable to have a food product in an insulated pouch that can be heated in a microwave oven whereby the food product may be consumed directly out of the insulated pouch. This invention, therefore, is directed to an insulated pouch with a food product therein. The insulated pouch can be held in the hand of a consumer after heating and the food product may be conveniently consumed out of the insulated pouch without the need for conventional dishware.

Additional Information

Efforts have been disclosed for making food packages. In U.S. Pat. No. 5,241,150, a microwave food package having an orifice to dispense foodstuff is described.

Other efforts have been disclosed for making food packages. In U.S. Pat. No. 6,183,789, meals packaged in mesh material are described.

Still other efforts have been disclosed for making food packages. In U.S. Application No. 2001/0001674 A1, a microwavable meal kit and food packaging system are described.

None of the additional information above describes an insulated pouch having heated food product therein whereby the food product may be consumed directly out of the insulated pouch without the need for conventional dishware and while being held in the consumer's hand after heating.

### SUMMARY OF THE INVENTION

In a first aspect, the present invention is directed to an insulated pouch comprising:
(a) a sealed flexible bag comprising a food product, the flexible bag not being permeable to water and having an opening means suitable to generate an opening large enough to enable a consumer to consume food product directly from the insulated pouch; and
(b) an insulating layer covering at least a portion of the sealed flexible bag
   wherein the insulated pouch can be heated in a microwave oven and held by a consumer after heating.

In a second aspect, the present invention is directed to a method for consuming a food product using the insulated pouch of the first aspect of this invention.

Flexible bag, as used herein, means a bag constructed out of polymeric material. Insulating layer means a layer that can surround at least a portion of the flexible bag and suitable to act as a heat barrier. Food product, as used herein, means a food item suitable for heating in a microwave oven and for consuming directly out of the insulated pouch of this invention. Consuming food product directly from the insulated pouch means by drinking food product, or eating food product with a fork or spoon. Preferably, consuming food product directly from the insulated pouch means with a fork or spoon. Held by a consumer after heating means comfortably held in the hand of the consumer (i.e., not burning) while the consumer is consuming all of the food product.

### BRIEF DESCRIPTION OF THE DRAWINGS

The subject matter regarded as the invention is particularly pointed out and distinctly claimed in the concluding portion of the specification. The invention, however, may be best understood by reference to the following description taken in conjunction with the accompanying drawing figures in which:

FIG. 1 is a perspective view of the insulated pouch of this invention;

FIG. 2 is a perspective view thereof;

FIG. 3 is a front plan view of the flexible bag of the insulated pouch;

FIG. 4 is a bottom plan view of the insulated pouch of this invention;

FIG. 5 shows components of the insulated pouch; and

FIG. 6 shows the insulated pouch with preferred indentations.

### DETAILED DESCRIPTION OF THE PREFERRED EMBODIMENTS

The general requirements of the flexible bag that may be used in the insulated pouch of this invention are that the bag can be closed (e.g., sealed), is suitable to hold a food product for heating in a microwave, is not permeable to water and is suitable to have an opening means that, when opened, is large enough to enable a consumer to consume food product directly from the insulated pouch, and preferably, with a fork or spoon.

Illustrative examples of the types of material that can be used to make the flexible bag of the insulated pouch of this invention include, but are not limited to, a polyolefin, polypropylene, polyethylene, polyester, polyimide, polyamide, blends thereof, copolymers thereof and the like. In a preferred embodiment, the flexible bag of this invention is constructed of at least two layers wherein the inner layer is heat sealable to itself, and the outer layer provides strength and support to the heat sealable layer and acts as a moisture barrier to protect the food product within the flexible bag. In a most preferred embodiment, the flexible bag of this invention has a heat sealable inner layer comprising polyester or polyethylene. In another most preferred embodiment, the flexible bag of this invention has an outer support layer comprising polyimide, polyamide, polyester or polypropylene.

Regarding the flexible bag, it is within the scope of this invention to incorporate an oxygen barrier layer into the same so that the shelf life of the food products (especially ambient stable products) is prolonged. In a preferred embodiment, the oxygen barrier layer is located in between the inner and outer layers and comprises polyvinylidene chloride, ethylene vinyl alcohol or a combination thereof.

The flexible bag suitable for use in this invention may be made by conventional techniques that include, without limitation, co-extrusion steps, laminating steps or both co-extrusion and laminating steps. Preferred flexible bags suitable for use with this invention are often made available from suppliers like Amcor Corporation, Douglas Plastics and CLP Packaging Solutions, Inc.

The insulating layer suitable to cover at least a portion of the flexible bag may be made of any material that does not interfere with the integrity of the flexible bag and heating process with microwaves, and that has the thermal ability to enable handling of the flexible bag immediately after heating. In addition to allowing for handling, it is preferred for the insulating layer to enhance heat retention of the insulated pouch after the food product is heated.

Illustrative examples of the types of materials that may be used to make the insulating layer are paperboard, foams of polyester, polypropylene, blends thereof or copolymers thereof. The preferred foams suitable for use in the insulating layer are those comprising polyester and/or polypropylene, as made commercially available from suppliers like Cryovac Sealed Air Corporation and E.I. duPont de Nemours & Company. The paperboard suitable for use in this invention is made available from suppliers like MeadWestvaco Corporation and Graphic Packaging Corporation.

In a preferred embodiment, at least about 50%, and preferably, at least about 60%, and most preferably, at least about 65% to about 85% of the total outer surface area of flexible bag is covered by the insulating layer.

The food products suitable for use in the insulated pouches of this invention are those which are often heated in a microwave oven. Such food products can comprise soups, pastas meats, rice, potatoes, cheese, (e.g., for dipping food items like chips) vegetables or a combination thereof and may be shelf stable or require refrigeration. Preferred superior food products for use with the insulated pouch of this invention are made commercially available by Unilever Bestfoods under, for example, the Lipton, Ragu, Bertoli and SlimFast brands.

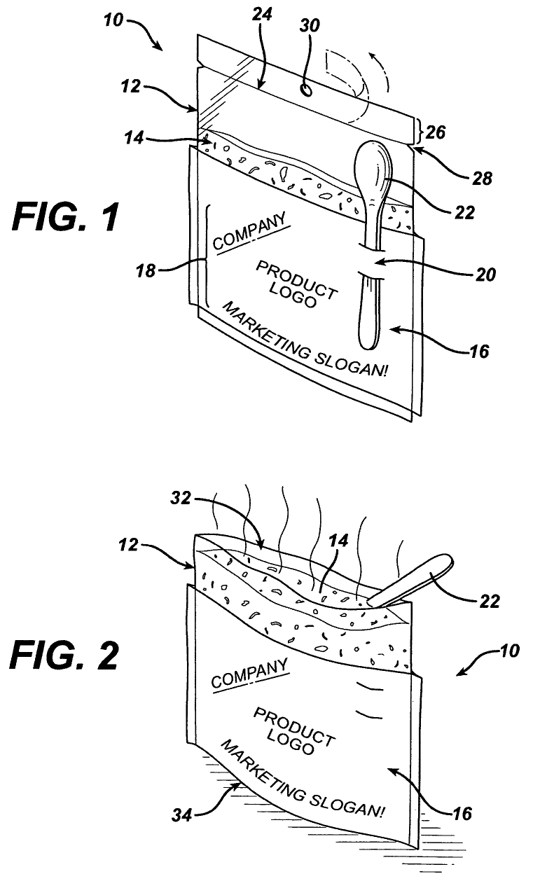

Turning to the Figures, FIG. 1 shows insulated pouch 10 comprising a sealed flexible bag 12 having a food product 14 packaged therein. Covering, at least a portion (preferably on both sides) of the sealed flexible bag 12, is insulating layer 16 which may optionally comprise adversizing material 18 in the form of, for example, a company name, product logo, marketing slogan or combination thereof, as well as cooking instructions. Also, and optionally, insulating layer 16 can comprise an attaching means 20 (illustrated as a sleeve) so that an eating utensil 22 may be attached to the insulated pouch 10 via the attaching means 20 of the insulating layer 16. Insulated pouch 10 further comprises an opening means 24 that can be pulled apart (i.e., is zipper-like or comprising a tearable adhesive), cut or torn so that a consumer, not shown, can have access to food product 14 with eating utensil 22. In a preferred embodiment, the opening means 24 is a tear line, torn by a consumer by gripping the insulated pouch 10 with one hand and pulling a top section 26 of the insulated pouch 10 with the other hand at tear notch 28. Top section 26 may optionally comprise an orifice 30 to hang the insulated pouch, for example, in a vending machine or store display case (both not shown).

Turning to FIG. 2, shown is insulated pouch 10 with food access opening 32 providing access to food product 14 with eating utensil 22. It is particularly noted that insulated pouch 10 preferably has a base 34 that occupies enough area to enable the insulated pouch 10 to stand when top section 26 is fully attached, torn or removed to result in the formation of the food access opening 32.

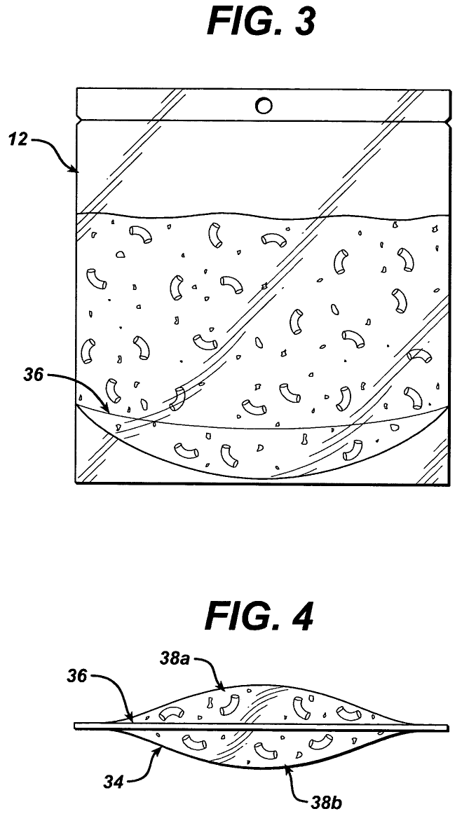

FIG. 3 is a front view of the flexible bag 12 optionally comprising a support member 36 (e.g., gusset) suitable for adding support to the insulated pouch 10. FIG. 4 is a bottom view of the insulated pouch 10 showing support member 36 and side lobes 38a and 38b projecting away from the support member 36 and towards the base 34.

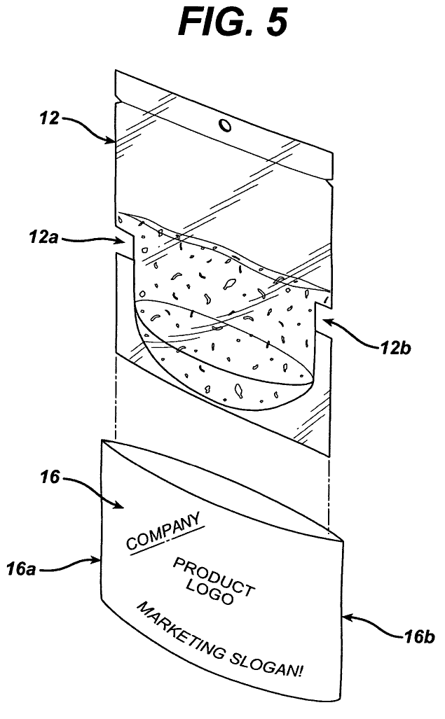

FIG. 5 shows flexible bag 12 and insulating layer 16 apart from each other and as segments of the insulated pouch 10. In a preferred embodiment, flexible bag 12 has at least one but preferably two notches 12a and 12b to assist in preventing insulating layer 16 from being separated from the flexible bag 12.

In an especially preferred embodiment, insulating layer 16 is sleeve-like and heat sealed (or glued with an adhesive) at edges 16a and 16b. In yet another especially preferred embodiment, insulating layer 16 is placed on the flexible bag 12 after the same is filled with food product 14 and sealed. Moreover, it is generally preferred that the bottom of insulating layer 16 is placed at least 0.5 cm higher than the bottom of flexible bag 12 so that the insulated pouch can stand, and preferably, from about 0.5 to about 3.0 cm higher than the bottom of the flexible bag 12. Also, it is generally preferred that the insulating layer 16 exceeds the sides of the flexible bag 12 by at least about 0.75 cm, and preferably, by at least about 1.0 cm to about 2.5 cm.

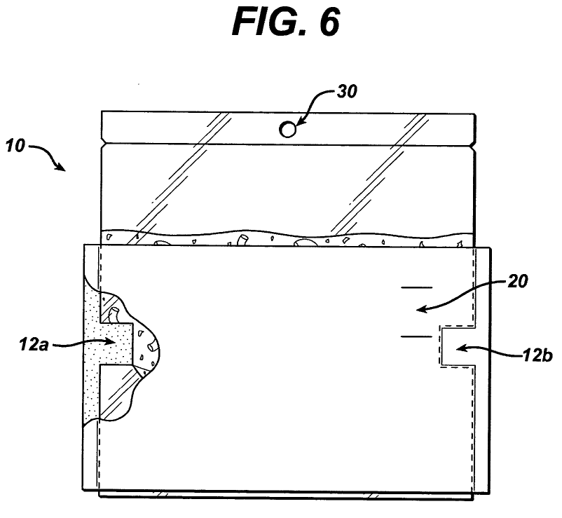

FIG. 6 shows insulated pouch 10 fully assembled and comprising optional features such as orifice 30, attaching means 20 and notches 12a and 12b.

It is particularly noted that in a most preferred embodiment, the walls which make up the flexible bag and the insulating layer are, independently, from about 50 to about 2000 microns thick. In another most preferred embodiment, the temperature of insulating layer at the portion that contacts the human hand is about 25 to about 50% less than the temperature of the food product after the food product is heated to the desired serving temperature in a microwave oven. Still in another most preferred embodiment, the insulated pouch of this invention is square or rectangular-like with dimensions that do not exceed 25.0 cm but are preferably between about 8.0 to about 15.0 cm.

It shall be understood that the foregoing summary and detailed description of the invention are not intended to be limiting, and are exemplary of the inventive features that are defined in the claims.

1. An insulated pouch comprising:
(a) a sealed flexible bag comprising a food product, the flexible bag not being permeable to water and having an opening means suitable to generate an access opening large enough to enable a consumer to consume food product directly from the insulated pouch; and
(b) an insulating layer covering at least a portion of the sealed flexible bag
wherein the insulated pouch can be heated in a microwave oven and held by a consumer after heating.

2. The insulated pouch according to claim 1 wherein the food product comprises soup, pasta, meat, rice, potato, cheese, vegetable or a combination thereof.

3. The insulated pouch according to claim 1 wherein the sealed flexible bag comprises polyolefin, polypropylene, polyethylene, polyester, polyimide, polyamide, blends thereof or copolymers thereof.

4. The insulated pouch according to claim 1 wherein the sealed flexible bag further comprises an oxygen barrier comprising polyvinylidene chloride, ethylene vinyl alcohol or both.

5. The insulated pouch according to claim 1 wherein the insulating layer comprises paperboard, polyester or polypropylene.

6. The insulated pouch according to claim 1 wherein the insulating layer covers at least about 50% of the flexible bag.

7. The insulated pouch according to claim 1 wherein the insulating layer covers from about 65% to about 85% of the flexible bag.

8. The insulated pouch according to claim 1 wherein the insulating layer comprises advertising material selected from the group consisting of a company name, product logo, marketing slogan and cooking instructions.

9. The insulated pouch according to claim 1 wherein the opening means is positioned towards a top portion of the insulated pouch.

10. The insulated pouch according to claim 9 wherein the opening means can be pulled, cut or torn in order to generate the access opening.

11. The insulated pouch according to claim 1 wherein the insulated pouch has a base suitable to enable the insulated pouch to stand.

12. The insulated pouch according to claim 1 wherein the insulating layer further comprises an attaching means for attaching an eating utensil.

13. The insulated pouch according to claim 1 wherein above the opening means is a top section that is suitable for tearing.

14. The insulated pouch according to claim 13 wherein the top section comprises an orifice to hang the insulated pouch.

15. The insulated pouch according to claim 11 wherein the insulating layer covers at least a portion of both sides of the flexible bag and is positioned from about 0.5 to about 3.0 cm above the base of the insulated pouch.

16. A method for consuming a food product comprising the steps of:
a) placing an insulated pouch in a microwave oven for a predetermined time to heat the food product;
b) removing the insulated pouch from the microwave oven; and
c) opening the insulated pouch and consuming the food product directly therefrom wherein the insulated pouch comprises:
(i) a sealed flexible bag comprising the food product, the flexible bag not being permeable to water and having an opening means suitable to generate an access opening large enough to enable a consumer to consume the food product directly from the insulated pouch; and
(ii) an insulating layer covering at least a portion of the sealed flexible bag,
further wherein the insulated pouch is suitable to be held directly in a hand of the consumer during food product consumption.

17. The method of consuming a food product according to claim 16 wherein the insulating layer covers at least about 50% of the flexible bag.

18. The method of consuming a food product according to claim 16 wherein the food product comprises soup, pasta, meat, rice, potato, cheese, vegetable or a combination thereof.

19. The method of consuming a food product according to claim 16 wherein the insulating layer further comprises an attaching means for attaching an eating utensil.
